(19) United States
(12) Patent Application Publication
(10) Pub. No.: US 2024/0302179 A1
(43) Pub. Date: Sep. 12, 2024

(54) SYSTEM FOR ADDING LANDMARK POINTS TO A HIGH DEFINITION MAP AND ENHANCING LONGITUDINAL LOCALIZATION

(71) Applicant: GM Global Technology Operations LLC, Detroit, MI (US)

(72) Inventors: Brent Navin Roger Bacchus, Sterling Heights, MI (US); Guangyu Zou, Warren, MI (US); Bo Yu, Troy, MI (US)

(21) Appl. No.: 18/181,038

(22) Filed: Mar. 9, 2023

(51) Int. Cl. G01C 21/00

(52) U.S. Cl. CPC G01C 21/3811; G01C 21/3819; G01C 21/3848; G01C 21/3881

(57) ABSTRACT

A map updating system for a vehicle includes one or more input devices. The input device generates an input signal associated with data indicative of multiple landmark points relative to multiple road semantic features. The system further includes a computer having one or more processors that receive the input signal. The computer further includes a non-transitory computer readable storage medium for storing instructions. The processor is programmed to build a local map including the road semantic features and the landmark points. The processor is further programmed to determine a radius of road curvature associated with each road semantic feature and compare the radius of road curvature to a maximum radius of curvature threshold. The processor is further programmed to transmit an update signal to a cloud server, in response the processor determining that the radius of road curvature is less than the maximum radius of curvature threshold.

### INTRODUCTION

The present disclosure relates to constructing and updating high definition maps, and more particularly to a constructing and updating high definition maps to include landmark points to support enhanced longitudinal localization.

Automotive manufacturers and suppliers are continuously investigating systems for constructing high definition maps. In one example, autonomous vehicles may rely on high definition maps for locating the vehicles and making decisions on driving paths and driving strategies. A dedicated professional mapping vehicle may collect and construct a plurality of characteristics of a road environment in a specific area. However, these maps may cover only the areas travelled by the professional mapping vehicles, and the limited coverage may in turn limit the range of activities of autonomous vehicles. In addition, the high definition maps may contain only semantic features (e.g. lane markings, signs, etc.). Because certain areas of a road environment may include a straight length of road without any turns or road curvature, the system may not provide precise longitudinal localization.

Thus, while the current map construction systems achieve their intended purpose, there is a need for a new and improved warning system that addresses these issues.

### SUMMARY

According to several aspects, a map updating system for a vehicle includes one or more input devices attached to the vehicle. The input device generates an input signal associated with data indicative of multiple road semantic features and multiple landmark points positioned relative to the road semantic features. The system further includes a computer attached to the vehicle. The computer includes one or more processors communicating with the input device and receiving the input signal from the input device. The computer further includes a non-transitory computer readable storage medium for storing instructions, such that the processor is programmed to identify the road semantic features and the landmark points, in response to the processor receiving the input signal from the input device. The processor is further programmed to build a local map including the road semantic features and the landmark points positioned relative to the road semantic features. The processor is further programmed to determine a radius of road curvature associated with each road semantic feature. The processor is further programmed to compare the radius of road curvature to a maximum radius of curvature threshold. The processor is further programmed to transmit an update signal to a cloud server, in response the processor determining that the radius of road curvature is less than the maximum radius of curvature threshold. The cloud server is programmed to align the local map with an associated geo-tile of a high definition map, in response to the cloud server receiving the update signal from the processor. The cloud server is programmed to determine an alignment error and compare the alignment error to first and second alignment error thresholds. The first alignment error threshold is greater than the second alignment error threshold. The cloud server is programmed to replace the associated geo-tile of the high definition map with the local map and georeferences the landmark points, in response to the cloud server determining that the alignment error is not above the first alignment error threshold and above the second alignment error threshold. The cloud server is further programmed to fuse the local map with the associated geo-tile of the high definition map and georeferences the landmark points, in response to the cloud server determining that the alignment error is not above the first and second alignment error thresholds.

In one aspect, the processor is further programmed to determine a size of the local map and compare the size of the local map to a map size threshold. The processor is further programmed to delete a predetermined portion of the local map, in response to the processor determining that the size of the local map is not below the map size threshold.

In another aspect, the input devices include a Global Positioning System device and an Inertial Measurement Unit that generate the input signal associated with data indicative of an associated one of a motion of the vehicle and a region where the vehicle is located.

In another aspect, the processor is further programmed to build the local map by using at least one of a Structure From Motion technique and a Simultaneous Localization And Mapping technique to fuse the road semantic features and the landmark points with the motion of the vehicle and the region where the vehicle is located.

In another aspect, the input device further includes a camera, a radio detection and ranging sensor, and/or a light detection and ranging sensor.

In another aspect, the cloud server aligns the road semantic features of the local map with multiple global semantic features of the associated geo-tile of the high definition map.

In another aspect, the cloud server georeferences the landmark points, in response to the cloud server aligning the road semantic features with the global semantic features.

In another aspect, the cloud server is further programmed to discretize a plurality of global semantic curves associated with the global semantic features into a plurality of global points. The cloud server is further programmed to discretize a plurality of local semantic curves associated with the road semantic features into a plurality of local points. The cloud server is further programmed to identify a global point on a corresponding global semantic curve in the global map that is within a predetermined distance from one of the local points for the associated local semantic curve. The cloud server is further programmed to rotate and translate the local map for each of the local points for aligning the local map and the high definition map with one another for aligning the local map and the high definition map with one another.

In another aspect, the cloud server is further programmed to determine a vector of bond associated with a direction and a strength of a bond between a local point cloud and a global point cloud. The local point cloud includes a plurality of local points discretized from a plurality of local semantic features associated with the road semantic features. The global point cloud includes a plurality of global points discretized from a plurality of global semantic features associated with the global semantic features.

In another aspect, the cloud server fuses two or more of the local maps with the high definition map.

According to several aspects, a computer is provided for a map updating system of a vehicle, with the computer being attached to the vehicle. The computer includes one or more processor communicating with one or more input devices and receiving an input signal from the input device. The computer further includes a non-transitory computer readable storage medium for storing instructions, such that the processor is programmed to identify multiple road semantic features and multiple landmark points, in response to the processor receiving the input signal from the input device. The processor is further programmed to build a local map including the road semantic features and the landmark points. The processor is further programmed to determine a radius of road curvature associated with each road semantic feature. The processor is further programmed to compare the radius of road curvature to a maximum radius of curvature threshold. The processor is further programmed to transmit an update signal to a cloud server, in response the processor determining that the radius of road curvature is less than the maximum radius of curvature threshold.

In one aspect, the processor is further programmed to determine a size of the local map and compare the size of the local map to a map size threshold. The processor is further programmed to delete a predetermined portion of the local map, in response to the processor determining that the size of the local map is not below the map size threshold.

In another aspect, the processor is further programmed to build the local map by using at least one of a Structure From Motion technique and a Simultaneous Localization And Mapping technique to fuse the road semantic features and the landmark points with a motion of the vehicle and a region where the vehicle is located.

According to several aspects, a method is provided for operating a map updating system of a vehicle. The method includes generating, using one or more input devices attached to the vehicle, an input signal associated with data indicative of multiple road semantic features and multiple landmark points that are positioned relative to the road semantic features. The method further includes identifying, using one or more processors of a computer, the road semantic features and the landmark points, in response to the processor receiving the input signal from the input device. The method further includes building, using the processor, a local map having the road semantic features and the landmark points. The method further includes determining, using the processor, a radius of road curvature associated with each road semantic feature; comparing, using the processor, the radius of road curvature to a maximum radius of curvature threshold. The method further includes transmitting, using the processor, an update signal to a cloud server, in response the processor determining that the radius of road curvature is less than the maximum radius of curvature threshold. The method further includes aligning, using the cloud server, the local map with an associated geo-tile of a high definition map, in response to the cloud server receiving the update signal from the processor. The method further includes determining, using the cloud server, an alignment error and comparing the alignment error to first and second alignment error thresholds. The first alignment error threshold is greater than the second alignment error threshold. The method further includes replacing, using the cloud server, the associated geo-tile of the high definition map with the local map and georeferences the landmark points in response to the cloud server determining that the alignment error is not above the first alignment error threshold and above the second alignment error threshold; and fusing, using the cloud server, the local map with the associated geo-tile of the high definition map and georeferences the landmark points, in response to the cloud server determining that the alignment error is not above the first and second alignment error thresholds.

In one aspect, the method further includes determining, using the processor, a size of the local map and comparing the size of the local map to a map size threshold. The method further includes deleting, using the processor, a predetermined portion of the local map, in response to the processor determining that the size of the local map is not below the map size threshold.

In another aspect, the method further includes generating, using a Global Positioning System device and/or an Inertial Measurement Unit, the input signal associated with data indicative of an associated one of a motion of the vehicle and a region where the vehicle is located.

In another aspect, the method further includes building, using the processor, the local map by using at least one of a Structure From Motion technique and a Simultaneous Localization And Mapping technique to fuse the road semantic features and the landmark points with the motion of the vehicle and the region where the vehicle is located.

In another aspect, the method further includes aligning, using the cloud server, the road semantic features of the local map with multiple global semantic features of the associated geo-tile of the high definition map.

In another aspect, the method further includes georeferencing, using the cloud server, the landmark points, in response to the cloud server aligning the road semantic features with the global semantic features. The method further includes discretizing, using the cloud server, multiple global semantic curves associated with the global semantic features into multiple global points. The method further includes discretizing, using the cloud server, multiple local semantic curves associated with the road semantic features into multiple local points. The method further includes identifying, using the cloud server, a global point on a corresponding global semantic curve in the global map that is within a predetermined distance from one of the local points for the associated local semantic curve. The method further includes rotating and translating, using the cloud server, the local map for each of the local points.

In another aspect, the method further includes determining, using the cloud server, a vector of bond associated with a direction and a strength of a bond between a local point cloud and a global point cloud. The local point cloud includes multiple local points discretized from multiple local semantic features associated with the road semantic features. The global point cloud includes multiple global points discretized from multiple global semantic features associated with the global road semantic features.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of one non-limiting example of a map updating system having a cloud server and a computer attached to a vehicle, with the vehicle being located on a road segment having a radius of road curvature and multiple landmark points.

FIG. 2 is a schematic view of a geo-tile of a high definition map stored in the cloud server of FIG. 1.

FIG. 3 is a schematic view of a local map generated by the computer and aligned with the associated geo-tile of FIG. 2.

FIG. 4 is a schematic view of the cloud server and the computer of the vehicle of FIG. 1.

FIG. 5 is a schematic view of a first frame of a local map built by the computer of FIG. 1.

FIG. 6 is a schematic view of a second frame of the local map built by the computer of FIG. 1.

FIG. 7 is a schematic view of the first and second frames of the local map aligned with the geo-tile of the high definition map by the cloud server of FIG. 1.

FIG. 8 is a schematic view of a first local map having a lateral vector of bond with the geo-tile of the high definition map and a second local map having a lateral and longitudinal vector of bond with the geo-tile of the high definition map stored in the cloud server of FIG. 1.

FIG. 9 is a schematic view of the first and second local maps being aligned by the cloud server with the geo-tile of the high definition map to register the landmark points in the high definition map stored in the cloud server.

FIG. 10 is a flow chart of one non-limiting example of a method of operating the system of FIG. 1.

### DETAILED DESCRIPTION

The following description is merely exemplary in nature and is not intended to limit the present disclosure, application, or uses.

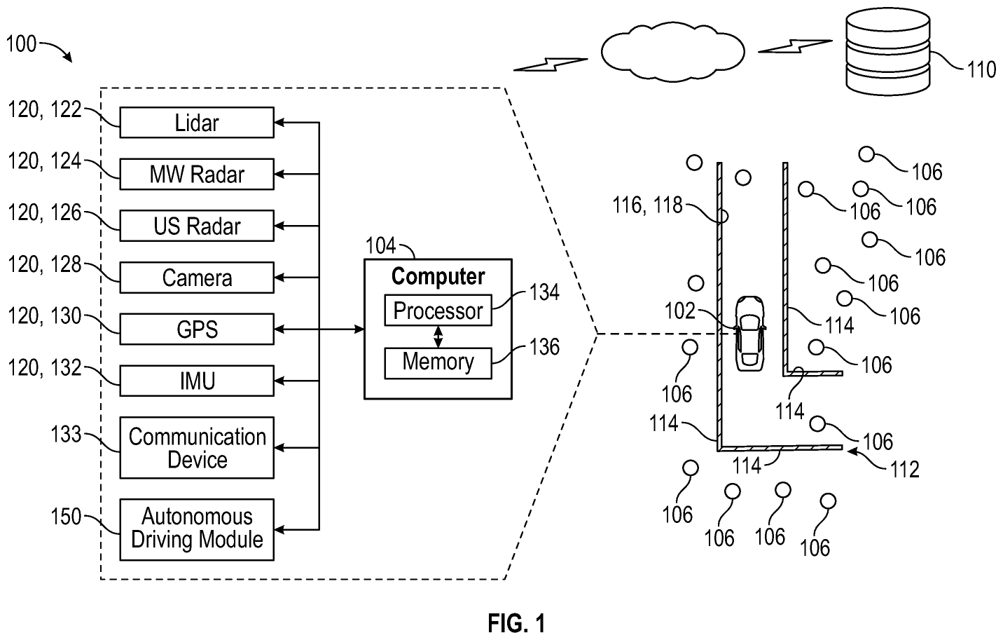

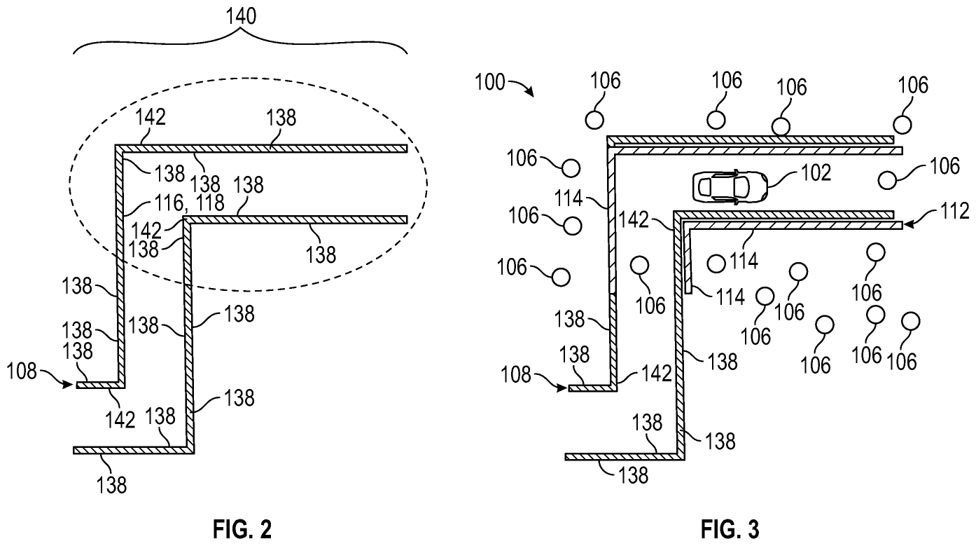

Referring to FIG. 1, there is generally illustrated one non-limiting example of a map updating system 100, with the system 100 including a vehicle 102 having an onboard computer 104 that georeferences and registers landmark points 106 to a high definition map 108 (FIGS. 2 and 3) stored in a cloud server 110 to, for example, enable autonomous driving when global positioning system signals are not available and/or only longitudinal road semantic features are present. As described in detail below, the computer 104 builds a local map 112 with road semantic features 114 (e.g., lane markings, traffic signs, etc.) spatially located relative to the vehicle 102 and landmark points 106 (e.g., streetlamps, corners of buildings, etc.) spatially located relative to the road semantic features 114. The system 100 further includes a cloud server 110 for georeferencing the local map 112 by aligning the road semantic features 114 having road curvature with the global road semantic features having associated road curvature stored in the high definition map 108 and then adding or registering the landmark points 106 in the high definition map 108 to enhance longitudinal localization (i.e., improving accuracy in determining both a lateral and longitudinal position of the vehicle 102 in a georeferenced or absolute coordinate system when only longitudinal lane markings are present and/or global positioning system signals are not available, etc.). The system 100 further simultaneously registers multi-point clouds to fuse local and high definition maps.

Each landmark point 106 may include the visual feature information of the landmark point 106 and the three-dimensional space information of the landmark point 106. Taking the street lamp as an example, a corresponding landmark point 106 in the local map may include the visual features (such as shape, contour, texture, color, etc.) of the street lamp, as well as the position information and dimensional information of the street lamp in space. In one non-limiting example, an autonomous driving vehicle may locate itself based on the visual feature information and three-dimensional spatial information of multiple road signs.

In this non-limiting example, the vehicle 102 travels along a route 116 on a road 118 and may be a common autonomous driving vehicle, rather than a professional mapping vehicle equipped with professional mapping equipment. The system 100 may include one or more input devices 120 (FIG. 1) attached to the vehicle 102 for collecting surrounding environmental data with a certain mapping capability. The input devices 120 may be a simple mapping device with a certain mapping capability. For example, the simple mapping device may be installed on a private car. During the daily driving of the private car, the simple mapping device may collect surrounding environment data and then perform mapping.

Referring to FIG. 1, the input devices 120 may generate an input signal associated with data indicative of the road semantic features spatially positioned relative to the vehicle and the landmark points spatially positioned relative to the road semantic features. The input device 120 may include a sensor group used by the common autonomous driving vehicle for normal driving, such as a light detection and ranging sensor 122, a millimeter wave radio detection and ranging sensor 124, an ultrasonic radio detection and ranging sensor 126, a camera 128 (e.g., monocular camera, binocular camera, etc.). The input devices 120 further include a Global Positioning System device 130 and an Inertial Measurement Unit 132 generating the input signal associated with data indicative of a motion of the vehicle and a region where the vehicle is located. In other non-limiting examples, the positioning technology may be based on Global Navigation Satellite System, Compass Navigation System, Galileo Positioning System, Quasi-Zenith Satellite System, Wireless Fidelity positioning technology, etc., or any combination thereof. One or more of the above positioning systems may be used interchangeably.

The system 100 further includes a computer 104 attached to the vehicle 102. In one non-limiting example, the computer 104 may be an External Object Calculating Module, which is a central computer for two or more vehicle safety systems. In another non-limiting example, the system 100 may include a Controller Area Network for allowing multiple microcontrollers and devices of other systems to communicate with the applications of one another without the dedicated computer 104. The computer 104 may further include one or more of processors 134 for communicating with the input devices 120. In this non-limiting example, the processor 134 receives the input signal from an associated one of the input devices 120.

The computer 104 further includes a non-transitory computer readable storage medium 136 (“memory”) storing instructions, such that the processor 134 is programmed to identify the road semantic features 114 and the landmark points 106, in response to the processor 134 receiving the input signal from the input device 120.

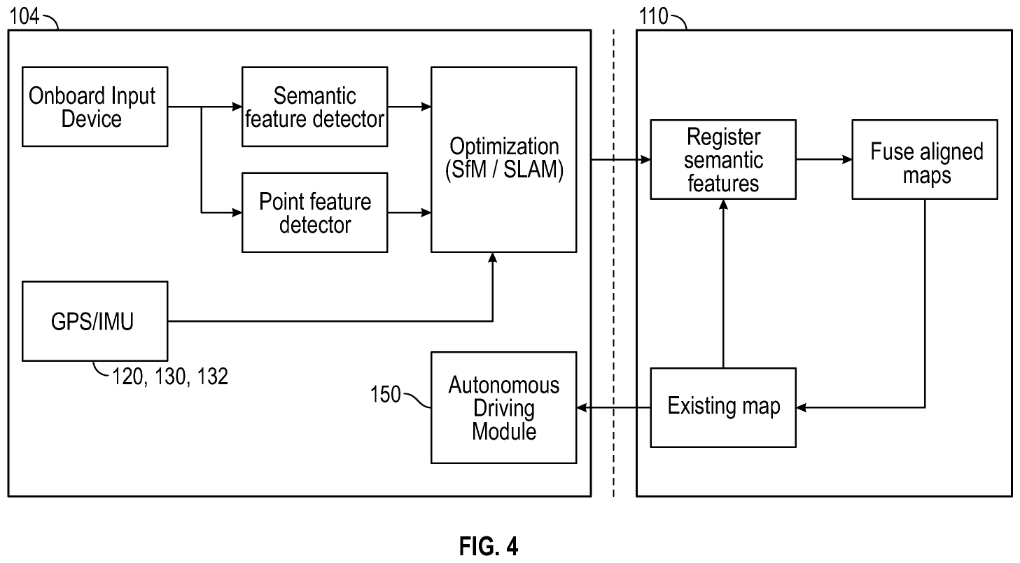

The processor 134 is further programmed to build the local map 112 (FIGS. 1 and 3) including the road semantic features 114 and the landmark points 106. The processor 134 is further programmed to build the local map 112 by using a Structure From Motion technique and/or a Simultaneous Localization And Mapping technique (FIG. 4) to fuse the road semantic features 114 and the landmark points 106 with the motion of the vehicle 102 and the region where the vehicle 102 is located.

The processor 134 is further programmed to determine a size of the local map 112 and compare the size of the local map 112 to a map size threshold. The processor is further programmed to delete a predetermined portion of the local map 112, in response to the processor 134 determining that the size of the local map is not below the map size threshold.

The processor 134 is further programmed to determine a radius of road curvature associated with each road semantic feature 114 and compare the radius of road curvature to a maximum radius of curvature threshold. The processor 134 is further programmed to transmit an update signal to a cloud server 110 in response the processor 134 determining that the radius of road curvature is less than the maximum radius of curvature threshold.

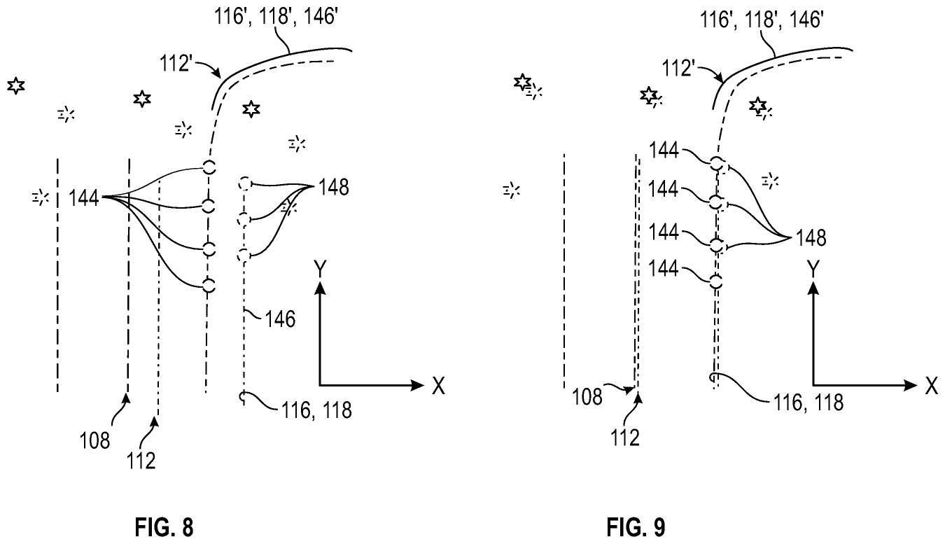

The cloud server 110 is programmed to align the road semantic features 114 of the local map 112 with a plurality of global semantic features 138 of the associated geo-tile 140 of the high definition map 108 (FIGS. 2, 3, and 7), in response to the cloud server 110 receiving the update signal from the processor 134. More specifically, in one non-limiting example, the cloud server 110 is programmed to discretize a plurality of global semantic curves 142 associated with the global semantic features 138 into a plurality of global points 144 (FIGS. 8 and 9). The cloud server 110 is further programmed to discretize a plurality of local semantic curves 146 associated with the road semantic features 114 into a plurality of local points 148 (FIGS. 8 and 9). The cloud server 110 is further programmed to identify a global point on a corresponding global semantic curve in the high definition map 108 that is within a predetermined distance from one of the local points 148 for the associated local semantic curve 146. The cloud server 110 is further programmed to rotate and translate the local map 112 for each of the local points 148 for aligning the local map 112 and the high definition map 108 with one another.

The cloud server 110 may be programmed to determine an alignment error and compare the alignment error to first and second alignment error thresholds, with the first alignment error threshold being greater than the second alignment error threshold. The cloud server replaces the associated geo-tile of the high definition map with the local map and georeferences the landmark points in response to the cloud server determining that the alignment error is not above the first alignment error threshold and above the second alignment error threshold. The cloud server fuses the local map with the associated geo-tile of the high definition map and georeferences the landmark points in response to the cloud server determining that the alignment error is not above the first and second alignment error thresholds.

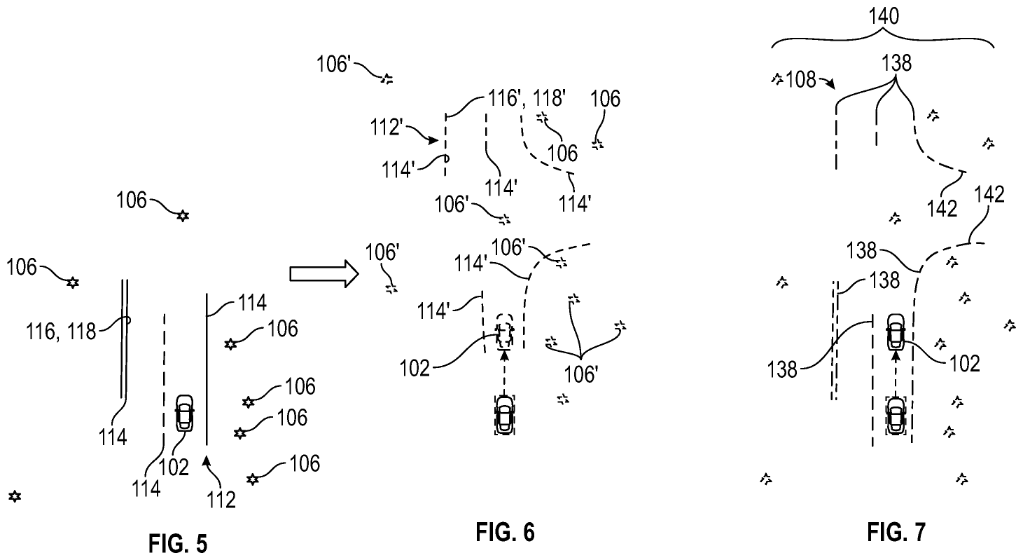

Referring generally to FIGS. 5-9, the cloud server is further programmed to determine a vector of bond associated with a direction and a strength of a bond between a local point cloud and a global point cloud, with the local point cloud including a plurality of local points discretized from a plurality of local semantic features associated with the road semantic features, and the global point cloud including a plurality of global points discretized from a plurality of global semantic features associated with the global semantic features. The cloud server is further programmed to fuse two or more of the local maps 112, 112′ with the high definition map 108. The cloud server 110 georeferences the landmark points 106, in response to the cloud server 110 aligning the road semantic features 114 with the global semantic features 138.

In this non-limiting example, the system 100 may further include a data interaction link 133 established between the computer 104 of vehicle 102 and the cloud server 110, such that vehicle 102 may upload the local map of a reconstructed area to the cloud server, thereby updating the part or geo-tile of the high definition map corresponding to the area. In some non-limiting examples, the vehicle can include an autonomous driving module 150 and use the map in the form of a visual positioning map that in turn includes the landmark points. Each landmark point may include the visual feature information of the landmark point and the three-dimensional space information of the landmark point. A corresponding landmark point in the visual positioning map may include the visual features (such as shape, contour, texture, color, etc.) of the landmark point 106, as well as the position information and dimensional information of the landmark point in space. An autonomous driving vehicle may locate itself based on the visual feature information and three-dimensional spatial information of multiple road signs.

Compared with the local map 112, the high definition map 108 may include a larger area, such as a map of a city, a map of a country, and so on. The system 100 permits a common vehicle with the map updating system 100 to collect environmental data around a road section it drives by during a normal driving process and then upload the collected data to the cloud server 110, so as to update a corresponding geo-tile of the high definition map 108. The mapping vehicle may include, but is not limited to, a common autonomous driving vehicle. A common autonomous driving vehicle may be a vehicle without professional mapping equipment, and the vehicle 102 may include one or more input devices 120 for mapping the surrounding environment as the vehicle travels in the area. The input devices 120 may include a Global Positioning System device 130 and an Inertial Measurement Unit 132 generating the input signal associated with data indicative of an associated one of a motion of the vehicle 102 and a region where the vehicle 102 is located.

In the case where the cloud server cannot provide a sufficiently detailed local map or the local map has errors, after a mapping vehicle downloads the local map from the cloud server, the processor 134 will collect data, preliminarily process the collected data and then upload the preliminarily processed data to the cloud server, so as to complete the supplementary construction of the cloud map. Alternatively, the system 100 may directly upload the collected data to the cloud server without data processing, and the cloud server completes the mapping work. Due to the huge amount of data of a visual positioning map, the data interaction process relies on sufficiently fast network uplink and downlink. For example, a 5G network or a network with a bandwidth of not less than 100 Mbps may provide a good network environment, which is helpful for updating a high definition map by a common automatic vehicle. It should be understood that a good network environment is conducive to the implementation of the method described in the present disclosure, such as a network with a bandwidth of 200 Mbps, 400 Mbps, and up to 1 Gbps.

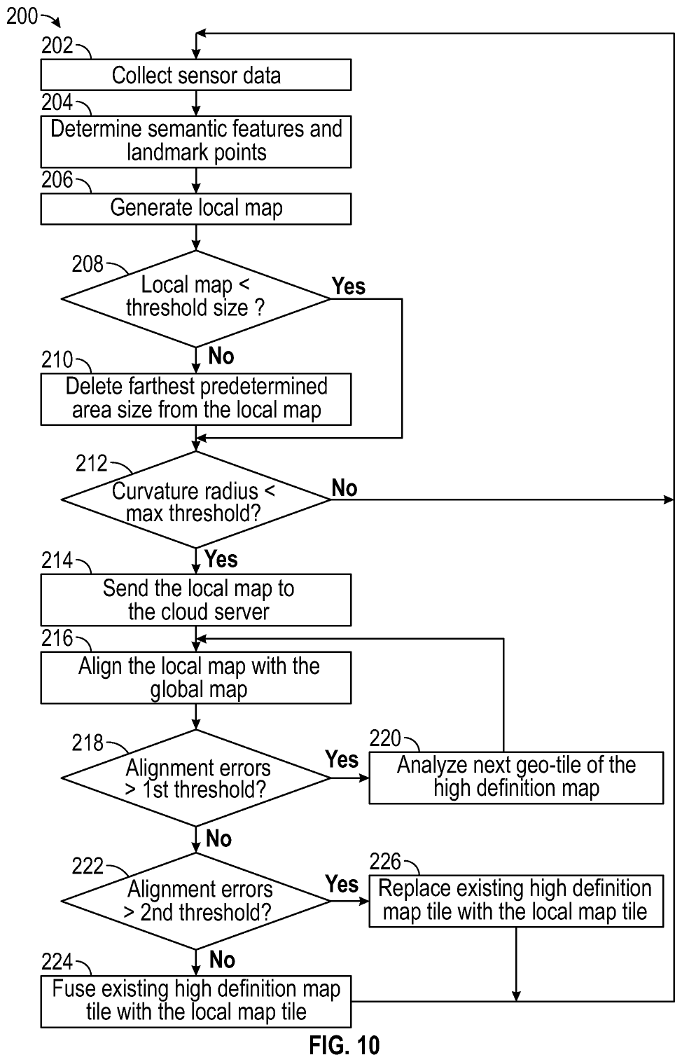

Referring to FIG. 10, one non-limiting example of a method 200 is provided for operating the system 100 of FIG. 1. The method 200 begins at block 202 with the input device 120 collecting sensor data and generating an input signal associated with data indicative of the road semantic features 114 that have positions relative to the vehicle 102 and the landmark points 106 that are positioned relative to the road semantic features 114. Non-limiting examples of the input devices 120 may include the light detection and ranging sensor 122, the millimeter wave radio detection and ranging sensor 124, the ultrasonic radio detection and ranging sensor 126, the camera 128 (monocular camera, binocular camera, etc.), the Global Positioning System device 130, and the Inertial Measurement Unit 132. In this example, the method 200 includes generating, using the Global Positioning System device and/or the Inertial Measurement Unit, the input signal associated with data indicative of a motion of the vehicle and a region where the vehicle is located. However, the system may include any other suitable input device collecting data indicative of the road semantic features 114 and the landmark points 106. The method 200 then proceeds to block 204.

At block 204, the method 200 further includes identifying, using the processor 134 of the computer 104, the road semantic features and the landmark points in response to the processor receiving the input signal from the input devices 120. The road semantic features may include lane markings, traffic signs, etc. that have positions spatially located relative to the vehicle 102. The landmark point 106 in the local map 112 may include the visual features (such as shape, contour, texture, color, etc.). The method 200 then proceeds to block 206.

At block 206, the method 200 further includes building, using the processor 134, the local map 112 (FIG. 1) including the road semantic features 114 and the landmark points 106. In this example, the method 200 includes building, using the processor 134, the local map 112 by using the Structure From Motion technique and/or the Simultaneous Localization And Mapping technique to fuse the road semantic features 114 and the landmark points 106 with the motion of the vehicle 102 and the region where the vehicle 102 is located. The method 200 then proceeds to block 208.

At block 208, the method 200 further includes determining whether the local map has exceeded a predetermined threshold size. More specifically, in this non-limiting example, the method 200 includes determining, using the processor 134, a size of the local map 112 and comparing the size of the local map 112 to a map size threshold (e.g., 100 meters to 200 meters, etc.). If the processor 134 determines that the size of the local map 112 is not below the map size threshold, the method 200 proceeds to block 210. If the processor 134 determines that the size of the local map 112 is below the map size threshold, the method 200 proceeds immediately to block 212.

At block 210, the method 200 further includes deleting, using the processor 134, a predetermined portion of the local map 112, in response to the processor 134 determining that the size of the local map 112 is not below the map size threshold. In this non-limiting example, the processor 134 may delete a portion of the local map that is located farther than 100 meters from the current position of the vehicle 102. Limiting the size of the local map 112 may reduce inaccuracies in local maps having a size larger than the threshold. The method 200 then proceeds to block 212. In other examples, the processor may be programmed to delete portions of the local map that is located farther or closer than 100 meters from the current location of the vehicle 102.

At block 212, the method 200 further includes determining whether the data collected by the input devices 120 provides both lateral and longitudinal localization. In this non-limiting example, the method 200 includes determining, using the processor 134, a radius of road curvature associated with each road semantic feature and comparing the radius of road curvature to a maximum radius of curvature threshold. If the radius of road curvature is less than the maximum radius of curvature threshold, the method 200 proceeds to block 214. If the radius of road curvature is not less than the maximum radius of curvature threshold, the method 200 returns to block 202.

At block 214, the method 200 further includes transmitting an update signal to the cloud server 110, in response the at processor 134 determining that the radius of road curvature is less than the maximum radius of curvature threshold. The method 200 the proceeds to block 216.

At block 216, the method 200 further includes aligning, using the cloud server 110, the local map 112 with the associated geo-tile 140 of the high definition map 108. More specifically, in this non-limiting example, the method 200 includes aligning, using the cloud server, the road semantic features of the local map with a plurality of global semantic features of the associated geo-tile of the high definition map. The method 200 may further include discretizing, using the cloud server 110, the plurality of global semantic curves 142 associated with the global semantic features 138 into the plurality of global points 144. The method 200 further includes discretizing, using the cloud server 110, the plurality of local semantic curves 146 associated with the road semantic features 114 into the plurality of local points 148. The method 200 further includes identifying, the cloud server 110, the global point on the corresponding global semantic curve in the high definition map 108 that is within a predetermined distance from one of the local points 148 for the associated local semantic curve 146. The method 200 further includes rotating and translating, using the cloud server 110, the local map 112 for each of the local points 148 to align the local map 112 and the high definition map 108 with one another. In another non-limiting example, the method 200 may include determining, using the cloud server 110, the vector of bond associated with the direction and the strength of the bond between the local point cloud and the global point cloud, with the local point cloud including the local points discretized from the local semantic features associated with the road semantic features, and the global point cloud including the global points discretized from the global semantic features associated with the global road semantic features. The method 200 then proceeds to block 218.

At block 218, the method 200 further includes determining, using the cloud server 110, an alignment error and determining whether the alignment error is greater than a threshold size. More specifically, in this non-limiting example, the method 200 includes comparing, using the cloud server 110, the alignment error to the first alignment error threshold. If the processor 134 determines that the alignment error is above the first alignment error threshold, the method 200 proceeds to block 220. If the processor 134 determines that the alignment error is not above the first alignment error threshold, the method 200 proceeds to block 222.

At block 220, the method 200 includes determining, using the cloud server 110, that the present geo-tile does not match the local map and analyzing the next geo-tile of the high definition map 108. The method 200 then returns to step 216 to analyze and align the local map with the next geo-tile 140 of the high definition map 108.

At block 222, the method 200 includes comparing, using the cloud server 110, the alignment error to the second alignment error threshold, with the first alignment error threshold being above the second alignment error threshold. If the processor 134 determines that the alignment error is not above the second alignment error threshold, the method 200 proceeds to block 224. If the processor 134 determines that the alignment error is above the second alignment error threshold, the method 200 proceeds to block 226.

At block 224, the method 200 further includes fusing, using the cloud server 110, the local map 112 with the associated geo-tile 140 of the high definition map 108 and georeferencing the landmark points 106, in response to the cloud server 110 aligning the road semantic features 114 with the global semantic features 138 and in further response to the cloud server 110 determining that the alignment error is not above the second alignment error threshold. The method then returns to block 202.

At block 226, the method 200 further includes replacing, using the cloud server 110, the associated geo-tile 140 of the high definition map 108 with the local map 112 and georeferencing the landmark points 106, in response to the cloud server 110 aligning the road semantic features 114 with the global semantic features 138 and in further response to the cloud server 110 determining that the alignment error is above the second alignment error threshold. The method then returns to block 202.

In some non-limiting examples, at blocks 224 and 226, the method 200 may further include the processor 134 receiving the updated map from the cloud server 110, such that the autonomous driving module 150 can operate the vehicle 102 based on the updated map.

The flow charts provided in the present disclosure illustrate operations implemented by the system according to some exemplary embodiments of the present disclosure. It should be understood that the operations shown in the flow charts may be performed in a different order. The operations may be performed in a different order or performed simultaneously. In addition, one or more other operations can be added to the flow charts, and one or more operations can be removed from the flow charts.

In the present disclosure, the term “autonomous driving vehicle” may refer to a vehicle that has the ability to perceive its environment, and automatically perceive, judge and make decisions based on the external environment without human (e.g., a driver, a pilot, etc.) input and/or intervention. The terms “autonomous driving vehicle” and “vehicle” can be used interchangeably herein. The term “autonomous driving” may refer to the ability to make intelligent judgments and navigate the surrounding environment without human (e.g., a driver, a pilot, etc.) input. Moreover, the term “autonomous driving” herein may refer to any level of driving without or with only limited human intervention. For example, the term “autonomous driving” may include, but not limited to, any one of autonomous driving, automated driving, self-driving, and driverless as interchangeable.

Moreover, although the system and method provided in the present disclosure mainly describe the map update system and method that can be used for autonomous driving, it should be understood that these are only some exemplary embodiments. The system and method of the present disclosure can be applied to any other types of transportation systems. For example, the system and method of the present disclosure may be applied to various transportation systems in different environments, including land, sea, aerospace, etc., or any combination thereof. The autonomous driving vehicles of a transportation system may include, but are not limited to, taxis, private cars, trailers, buses, trains, bullet trains, high-speed railways, subways, ships, airplanes, spacecraft, hot air balloons, autonomous driving vehicles, etc., or any combination thereof. In some exemplary embodiments, the system and method of the present disclosure can find applications in logistics warehouses and military affairs, for example.

In general, the computing systems and/or devices described may employ any of a number of computer operating systems, including, but by no means limited to, versions and/or varieties of the ANDROID AUTOMOTIVE OS developed by GOOGLE INC., the MICROSOFT WINDOWS operating system, the UNIX operating system (e.g., the SOLARIS operating system distributed by ORACLE Corporation of Redwood Shores, California), the AIX UNIX operating system distributed by INTERNATIONAL BUSINESS MACHINES of Armonk, New York, the LINUX operating system, the MAC OSX and iOS operating systems distributed by APPLE INC. of Cupertino, California, the BLACKBERRY OS distributed by BLACKBERRY LTD. of Waterloo, Canada, and the OPEN HANDSET

ALLIANCE, or the QNX CAR Platform for Infotainment offered by QNX Software Systems. Examples of computing devices include, without limitation, an on board vehicle computer, a computer workstation, a server, a desktop, notebook, laptop, or handheld computer, or some other computing system and/or device.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, JAVA, C, C++, MATLAB, SIMULINK, STATEFLOW, VISUAL BASIC, JAVA SCRIPT, PERL, HTML, TENSORFLOW, PYTORCH, KERAS, etc. Some of these applications may be compiled and executed on a virtual machine, such as the JAVA VIRTUAL MACHINE, the DALVIK virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

The CRM that participates in providing data (e.g., instructions) may be read by the computer (e.g., by a processor of a computer and may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system, such as one of those mentioned above, and are accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A map updating system for a vehicle, the map updating system comprising:
at least one input device attached to the vehicle, the at least one input device generating an input signal associated with data indicative of a plurality of road semantic features and a plurality of landmark points that are positioned relative to the road semantic features;
a computer attached to the vehicle, the computer comprising:
at least one processor communicating with the at least one input device and receiving the input signal from the at least one input device; and
a non-transitory computer readable storage medium for storing instructions, such that the at least one processor is programmed to:
identify the road semantic features and the landmark points in response to the at least one processor receiving the input signal from the at least one input device;
build a local map including the road semantic features and the landmark points;
determine a radius of road curvature associated with each one of the road semantic features;
compare the radius of road curvature to a maximum radius of curvature threshold; and
transmit an update signal to a cloud server in response the at least one processor determining that the radius of road curvature is less than the maximum radius of curvature threshold;
wherein the cloud server is programmed to align the local map with an associated geo-tile of a high definition map in response to the cloud server receiving the update signal from the at least one processor;
wherein the cloud server determines an alignment error and compares the alignment error to first and second alignment error thresholds, with the first alignment error threshold being greater than the second alignment error threshold;
wherein the cloud server replaces the associated geo-tile of the high definition map with the local map and georeferences the landmark points in response to the cloud server determining that the alignment error is not above the first alignment error threshold and above the second alignment error threshold; and
wherein the cloud server fuses the local map with the associated geo-tile of the high definition map and georeferences the landmark points in response to the cloud server determining that the alignment error is not above the first and second alignment error thresholds.

2. The map updating system of claim 1 wherein the at least one processor is further programmed to:
determine a size of the local map;
compare the size of the local map to a map size threshold; and
delete a predetermined portion of the local map in response to the at least one processor determining that the size of the local map is not below the map size threshold.

3. The map updating system of claim 1 wherein the at least one input device comprises a Global Positioning System device and an Inertial Measurement Unit generating the input signal associated with data indicative of a motion of the vehicle and a region where the vehicle is located.

4. The map updating system of claim 3 wherein the at least one processor is further programmed to build the local map by using at least one of a Structure From Motion technique and a Simultaneous Localization And Mapping technique to fuse the road semantic features and the landmark points with the motion of the vehicle and the region where the vehicle is located.

5. The map updating system of claim 1 wherein the at least one input device further comprises at least one of a camera, a radio detection and ranging sensor, and a light detection and ranging sensor.

6. The map updating system of claim 1 wherein the cloud server aligns the road semantic features of the local map with a plurality of global semantic features of the associated geo-tile of the high definition map.

7. The map updating system of claim 6 wherein the cloud server georeferences the landmark points in response to the cloud server aligning the road semantic features with the global semantic features.

8. The map updating system of claim 7 wherein the cloud server is further programmed to:
discretize a plurality of global semantic curves associated with the global semantic features into a plurality of global points;
discretize a plurality of local semantic curves associated with the road semantic features into a plurality of local points;
identify a global point on a corresponding global semantic curve in the global map that is within a predetermined distance from one of the local points for the associated local semantic curve; and
rotate and translate the local map for each of the local points for aligning the local map and the high definition map with one another.

9. The map updating system of claim 7 wherein the cloud server is further programmed to determine a vector of bond associated with a direction and a strength of a bond between a local point cloud and a global point cloud, with the local point cloud including a plurality of local points discretized from a plurality of local semantic features associated with the road semantic features, and the global point cloud including a plurality of global points discretized from a plurality of global semantic features associated with the global semantic features.

10. The map updating system of claim 9 wherein the cloud server fuses at least two of the local maps with the high definition map.

11. A computer for a map updating system of a vehicle, with the computer attached to a vehicle, and the computer comprising:
at least one processor communicating with at least one input device and receiving an input signal from the at least one input device; and
a non-transitory computer readable storage medium for storing instructions, such that the at least one processor is programmed to:
identify a plurality of road semantic features and a plurality of landmark points in response to the at least one processor receiving the input signal from the at least one input device;
build a local map including the road semantic features and the landmark points;
determine a radius of road curvature associated with each one of the road semantic features;
compare the radius of road curvature to a maximum radius of curvature threshold; and
transmit an update signal to a cloud server in response the at least one processor determining that the radius of road curvature is less than the maximum radius of curvature threshold.

12. The computer of claim 11 wherein the at least one processor is further programmed to:
determine a size of the local map;
compare the size of the local map to a map size threshold; and
delete a predetermined portion of the local map in response to the at least one processor determining that the size of the local map is not below the map size threshold.

13. The computer of claim 11 wherein the at least one processor is further programmed to build the local map by using at least one of a Structure From Motion technique and a Simultaneous Localization And Mapping technique to fuse the road semantic features and the landmark points with a motion of the vehicle and a region where the vehicle is located.

14. A method for operating a map updating system of a vehicle, the method comprising:
generating, using at least one input device attached to the vehicle, an input signal associated with data indicative of a plurality of road semantic features and a plurality of landmark points that are positioned relative to the road semantic features;
identifying, using at least one processor of a computer, the road semantic features and the landmark points in response to the at least one processor receiving the input signal from the at least one input device;
building, using the at least one processor, a local map including the road semantic features and the landmark points;
determining, using the at least one processor a radius of road curvature associated with each one of the road semantic features;
comparing, using the at least one processor, the radius of road curvature to a maximum radius of curvature threshold;
transmitting, using the at least one processor, an update signal to a cloud server in response the at least one processor determining that the radius of road curvature is less than the maximum radius of curvature threshold;
aligning, using the cloud server, the local map with an associated geo-tile of a high definition map in response to the cloud server receiving the update signal from the at least one processor;
determining, using the cloud server, an alignment error and compares the alignment error to first and second alignment error thresholds, with the first alignment error threshold being greater than the second alignment error threshold;
replacing, using the cloud server, the associated geo-tile of the high definition map with the local map and georeferences the landmark points in response to the cloud server determining that the alignment error is not above the first alignment error threshold and above the second alignment error threshold; and
fusing, using the cloud server, the local map with the associated geo-tile of the high definition map and georeferences the landmark points in response to the cloud server determining that the alignment error is not above the first and second alignment error thresholds.

15. The method of claim 14 further comprising:
determining, using the at least one processor, a size of the local map;
comparing, using the at least one processor, the size of the local map to a map size threshold; and
deleting, using the at least one processor, a predetermined portion of the local map in response to the at least one processor determining that the size of the local map is not below the map size threshold.

16. The method of claim 14 further comprising generating, using at least one of a Global Positioning System device and an Inertial Measurement Unit, the input signal associated with data indicative of a motion of the vehicle and a region where the vehicle is located.

17. The method of claim 14 further comprising:
building, using the at least one processor, the local map by using at least one of a Structure From Motion technique and a Simultaneous Localization And Mapping technique to fuse the road semantic features and the landmark points with the motion of the vehicle and the region where the vehicle is located.

18. The method of claim 14 further comprising:
aligning, using the cloud server, the road semantic features of the local map with a plurality of global semantic features of the associated geo-tile of the high definition map.

19. The method of claim 18 further comprising:
georeferencing, using the cloud server, the landmark points in response to the cloud server aligning the road semantic features with the global semantic features;
discretizing, using the cloud server, a plurality of global semantic curves associated with the global semantic features into a plurality of global points;
discretizing, using the cloud server, a plurality of local semantic curves associated with the road semantic features into a plurality of local points;
identifying, using the cloud server, a global point on a corresponding global semantic curve in the global map that is within a predetermined distance from one of the local points for the associated local semantic curve; and
rotating and translating, using the cloud server, the local map for each of the local points.

20. The method of claim 19 further comprising:
determining, using the cloud server, a vector of bond associated with a direction and a strength of a bond between a local point cloud and a global point cloud, with the local point cloud including a plurality of local points discretized from a plurality of local semantic features associated with the road semantic features, and the global point cloud including a plurality of global points discretized from a plurality of global semantic features associated with the global road semantic features.
